(19) United States
(12) Patent Application Publication
(10) Pub. No.: US 2026/0230434 A1
(43) Pub. Date: Aug. 6, 2026

(54) Hierarchical Network Sub-Partitioning

(71) Applicant: MELLANOX TECHNOLOGIES, LTD., Yokneam (IL)

(72) Inventors: Rafi Ram, Herzeliya (IL); Ortal Bashan, Tel Aviv (IL); Alex Netes, Rehovot (IL); Ayal Lior, Kiryat Ono (IL)

(21) Appl. No.: 19/043,475

(22) Filed: Feb. 2, 2025

(51) Int. Cl. H04L 47/2483

(52) U.S. Cl. CPC H04L 47/2483

(57) ABSTRACT

A Network Management System (NMS) includes one or more network interfaces and one or more processors. The one or more network interfaces are to communicate with a communication network including multiple network devices, the network devices being connected (i) to one another via inter-device ports and (ii) to network endpoints via endpoint-facing ports. The one or more processors are to define a plurality of traffic domains arranged in a hierarchy having two or more levels, to associate the endpoint-facing ports of the network devices with respective ones of the traffic domains, and to configure the network devices (i) to assign incoming packets to the respective traffic domains that are associated with the endpoint-facing ports via which the incoming packets enter the communication network, and (ii) to permit forwarding of packets only within each of the traffic domains.

### TECHNICAL FIELD

The present disclosure relates generally to network communication, and particularly to isolating forwarding of network traffic using traffic domains.

### BACKGROUND

Some communication networks share their infrastructure and resources among clients, applications or other entities. In some scenarios it is important to maintain isolation between communication traffic of different entities. One possible isolation mechanism involves associating the traffic of each entity with a separate traffic domain, and marking the packets of each traffic domain with a respective domain identifier (ID).

Examples of domain identifiers include Virtual Local Area Networks (VLAN) IDs in IEEE 802.1 networks, Internet Protocol (IP) ports or Virtual eXtensible Local Area Networks (VXLAN) IDs in Internet Engineering Task Force (IETF) IP networks, Multiprotocol Label Switching (MPLS) labels in IETF MPLS networks, and partition keys (Pkeys) in InfiniBand™ (IB) networks.

### SUMMARY

A Network Management System (NMS) includes one or more network interfaces and one or more processors. The one or more network interfaces are to communicate with a communication network including multiple network devices, the network devices being connected (i) to one another via inter-device ports and (ii) to network endpoints via endpoint-facing ports. The one or more processors are to define a plurality of traffic domains arranged in a hierarchy having two or more levels, to associate the endpoint-facing ports of the network devices with respective ones of the traffic domains, and to configure the network devices (i) to assign incoming packets to the respective traffic domains that are associated with the endpoint-facing ports via which the incoming packets enter the communication network, and (ii) to permit forwarding of packets only within each of the traffic domains.

In some embodiments, the one or more processors are to configure the network devices to mark an incoming packet with a domain identifier that is (i) indicative of a traffic domain assigned to the incoming packet, but (ii) not indicative of the hierarchy.

In a disclosed embodiment, in response to adding a traffic domain to the plurality, the one or more processors are to (i) define a location of the traffic domain in the hierarchy, (ii) define a domain identifier for the traffic domain, (iii) update association of the endpoint-facing ports to account for the traffic domain, and (iv) reconfigure the network devices to account for the traffic domain.

In an example embodiment,, in response to terminating a traffic domain in the plurality, the one or more processors are to (i) remove the traffic domain from the hierarchy, (ii) release a domain identifier that was assigned to the traffic domain, and (iii) reconfigure the network devices to account for removal of the traffic domain.

There is additionally provided, in accordance with an embodiment that is described herein, a network device including multiple ports, forwarding circuitry, and a controller. The multiple ports are for sending and receiving packets to and from a communication network, one or more of the ports serving as endpoint-facing ports for connecting to endpoints of the communication network. The forwarding circuitry is to forward the packets between the ports. The controller is to receive a configuration from a Network Management System (NMS), and, responsively to the configuration, to configure the forwarding circuitry (i) to assign incoming packets, entering the network device via the endpoint-facing ports, to respective traffic domains that are associated with the endpoint-facing ports via which the incoming packets enter the network device, and (ii) to permit forwarding of the packets only within each of the traffic domains.

In some embodiments, responsively to the configuration, the forwarding circuitry is to mark an incoming packet with a domain identifier that is indicative of a traffic domain assigned to the incoming packet.

There is further provided, in accordance with an embodiment that is described herein, a network management method including defining a plurality of traffic domains for a communication network including multiple network devices that are connected (i) to one another via inter-device ports and (ii) to network endpoints via endpoint-facing ports, the traffic domains being arranged in a hierarchy having two or more levels. The endpoint-facing ports of the network devices are associated with respective ones of the traffic domains. The network devices are configured (i) to assign incoming packets to the respective traffic domains that are associated with the endpoint-facing ports via which the incoming packets enter the communication network, and (ii) to permit forwarding of packets only within each of the traffic domains.

There is also provided, in accordance with an embodiment that is described herein, a communication method including, in a network device including multiple ports for sending and receiving packets to and from a communication network, one or more of the ports serving as endpoint-facing ports for connecting to endpoints of the communication network, receiving a configuration from a Network Management System (NMS). Responsively to the configuration, (i) incoming packets, entering the network device via the endpoint-facing ports, are assigned to respective traffic domains that are associated with the endpoint-facing ports via which the incoming packets enter the network device, and (ii) forwarding of the packets is permitted only within each of the traffic domains.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a computing and communication system that uses hierarchical partitioning into traffic domains, in accordance with an embodiment that is described herein;

FIG. 2 is a table showing a multi-level hierarchy of traffic domains, in accordance with an embodiment that is described herein;

FIG. 3 is a table showing a mapping between endpoint-facing ports and traffic domains, in accordance with an embodiment that is described herein;

FIG. 4 is a flow chart that schematically illustrates a method for hierarchical partitioning into traffic domains, in accordance with an embodiment that is described herein; and

FIG. 5 is a block diagram that schematically illustrates a computing system that uses hierarchical partitioning into traffic domains, in accordance with another embodiment that is described herein.

### DETAILED DESCRIPTION OF EMBODIMENTS

### Overview

In a communication network having shared infrastructure, it is sometimes desirable to define a multi-level hierarchy of isolated traffic domains. Consider, for example, a data center whose resources are shared among multiple tenants. The traffic of each tenant is associated with a respective traffic domain. A given tenant, however, may share the resources it obtains from the data center among multiple entities, e.g., clients or applications, and require isolation between them. In other words, a given traffic domain may require sub-partitioning into isolated sub-domains. Some scenarios may call for additional levels of hierarchy.

Some network protocols provide mechanisms for “stacking” of domain identifiers. Examples include VLAN ID stacking, also referred to as “QinQ”, and stacking of MPLS labels. These solutions, however, add considerable bandwidth overhead in network messages, and require complex data-plane processing in network devices.

Embodiments that are described herein provide improved methods and systems for partitioning network traffic into a multi-level hierarchy of traffic domains.

In some disclosed embodiments, a Network Management System (NMS) manages a communication network comprising multiple network devices. In particular, the NMS defines a multi-level hierarchy of traffic domains for use in the communication network. The NMS configures the network devices to maintain “forwarding-isolation” between traffic domains, i.e., to permit forwarding packets only within each of the traffic domains. A given packet, however, is marked with only a single domain identifier. The multi-level hierarchy is managed by the control plane or management plane, e.g., by the NMS. Data-plane processing of packets in the network devices is based solely on the single domain identifier, agnostically to the hierarchy.

In some embodiments, the NMS associates incoming packets with traffic domains based on the “endpoint-facing ports” via which the packets enter the network. In the present context, the term “endpoint-facing port” refers to a port of a network device that is connected to a network endpoint, e.g., a server or other computer or processor. Ports that connect between network devices are referred to as “inter-device ports”.

In an example embodiment, the NMS defines a mapping that assigns each endpoint-facing port with one of the traffic domains in the hierarchy. The NMS configures the network devices (i) to assign incoming packets to the respective traffic domains that are associated with the endpoint-facing ports via which the packets enter the communication network, and (ii) to permit forwarding of packets only within each of the traffic domains.

Thus, when a packet enters the network via an endpoint-facing port of a certain network device, the network device marks the packet with the domain identifier of the traffic domain that is associated with the endpoint-facing port. Although the mapping between endpoint-facing ports and traffic domains depends on the multi-level hierarchy, the network devices are unaware of the underlying hierarchy and process the packets based on the domain identifiers. As a result, data-plane processing in the network devices is simplified. Moreover, since each packet is marked with a single domain identifier, only a modest amount of bandwidth overhead is added.

The disclosed technique is applicable to any suitable network protocol. Example implementations are described below. Techniques for seamless updating of the hierarchy, e.g., splitting a traffic domain or terminating a traffic domain, are also described.

### System Description

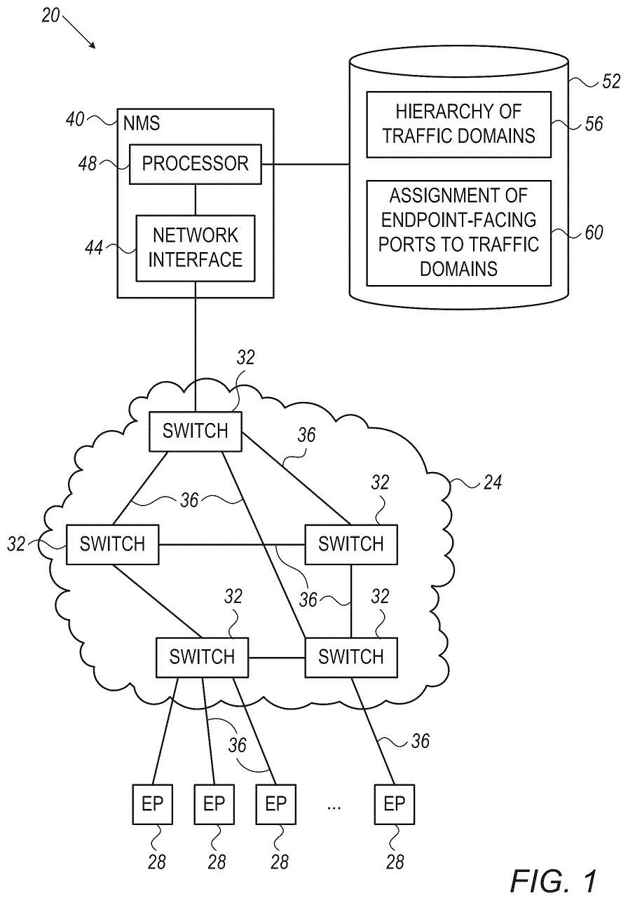

FIG. 1 is a block diagram that schematically illustrates a computing and communication system 20 that uses hierarchical partitioning into traffic domains, in accordance with an embodiment that is described herein. System 20 may comprise, for example, a data center, a High-Performance Computing (HPC) cluster, or any other suitable computing and communication system.

System 20 comprises a communication network 24 that serves a plurality of Endpoints (EPs) 28. EPs 28 may comprise, for example, servers, Graphics Processing Units (GPUs), Central Processing Units (CPUs), or any other suitable type of computers or processors. Network 24 may operate in accordance with any suitable network protocol, e.g., InfiniBand™ (IB) or Ethernet.

Network 24 comprises multiple network devices, in the present example packet switches 32. Other types of network devices may comprise, for example, routers. Switches 32 are connected to one another via network links 36. One or more of switches 32 are also connected to EPs 28 via network links 36.

A given switch 32 typically comprises multiple ports for connecting to network links 36. A switch port that is connected (by a link 36) to an EP 28 is referred to herein as an endpoint-facing port. A switch port that is connected (by a link 36) to another switch port is referred to herein as an inter-device port.

System 20 further comprises a Network Management System (NMS) 40 that manages network 24. In the present example, NMS 40 comprises a network interface 44 for connecting to network 24, and a processor 48 that carries out the various management tasks of the NMS. In alternative embodiments, NMS 40 may be distributed among multiple processors 48 that connect to network 24 via one or more network interfaces 44. The description that follows will refer to a single processor 48 for simplicity.

System 20 further comprises a memory 52 that is accessible to processor 48 of NMS 40. Processor 48 defines and stores in memory 52 (i) a hierarchy 56 of multiple traffic domains, and (ii) an assignment 60 of endpoint-facing ports to traffic domains. The use of these data structure in carrying out the disclosed techniques is described in detail below.

### Hierarchical Network Sub-Partitioning

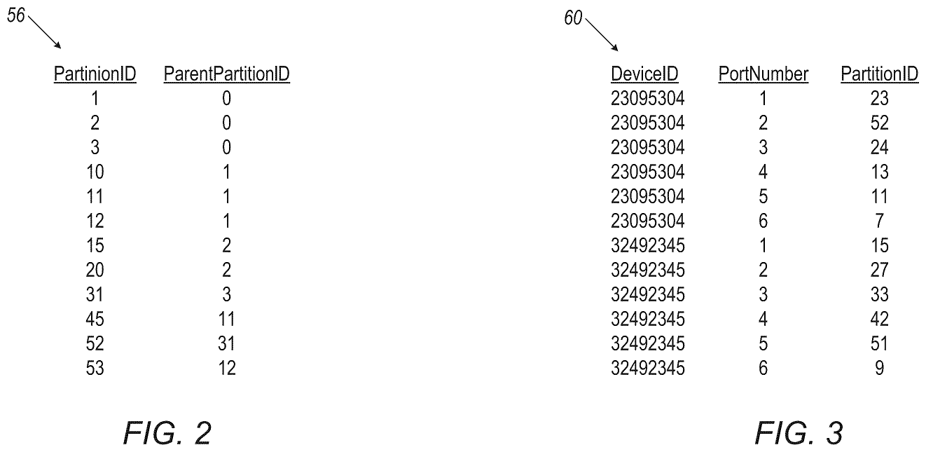

FIG. 2 is a table showing an example of multi-level hierarchy 56 of traffic domains, in accordance with an embodiment that is described herein. Hierarchy 56 is typically defined by processor 48 of NMS 40 and stored in memory 52.

In the present example, processor 48 represents hierarchy 56 by a table having multiple entries. Each entry specifies the following:
“PartitionID”—A domain identifier of a traffic domain.
“ParentPartitionID”—A domain identifier of the parent of the traffic domain in the hierarchy.

This representation enables defining any suitable hierarchical structure. Alternatively, processor 48 may define the multi-level hierarchy using any other suitable representation or data structure. Hierarchy 56 may comprise any suitable number of traffic domains arranged in any suitable number of levels.

FIG. 3 is a table showing an example of mapping 60 between endpoint-facing ports and traffic domains, in accordance with an embodiment that is described herein. Mapping 60 is typically defined by processor 48 of NMS 40 and stored in memory 52.

In the present embodiment, processor 48 represents mapping by a table having multiple entries. Each entry specifies the following:
“DeviceID”—An identifier of a network device, in the present example one of switches 32 of network 24.
“PortNumber”—An identifier of an endpoint-facing port of the switch.
“PartitionID”—An identifier of the traffic domain assigned to the endpoint-facing port.

The table of FIG. 3 is a non-limiting example of a representation of mapping 60. Alternatively, processor 48 may define the mapping between endpoint-facing ports and traffic domains using any other suitable representation or data structure.

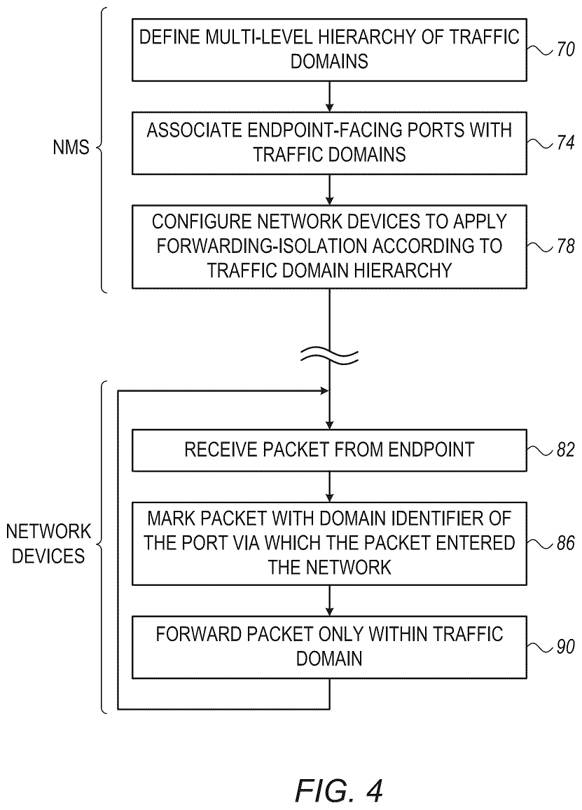

FIG. 4 is a flow chart that schematically illustrates a method for hierarchical partitioning into traffic domains, in accordance with an embodiment that is described herein.

Stages 70-78 of the method are carried out by NMS 40.

The method begins with processor 48 of NMS 40 defining a multi-level hierarchy of traffic domains, at a hierarchy definition stage 70. For example, processor 48 may define a hierarchy 56 of the kind depicted in FIG. 2. Processor 48 assigns each traffic domain in the hierarchy a respective domain identifier. Depending on the network protocol used in network 24, the domain identifiers may comprise, for example, VLAN IDs, IP ports, VXLAN IDs, MPLS labels, Pkeys, or any other suitable domain identifier.

At a mapping stage 74, processor 48 associates each endpoint-facing port of switches 32 with one of the traffic domains. For example, processor 48 may define a mapping 60 of the kind depicted in FIG. 3.

At a network device configuration stage 78, processor 48 configures switches 32 to apply forwarding-isolation in accordance with the traffic domain hierarchy. In some embodiments, applying forwarding-isolation involves:
Marking each packet that enters the network with the domain identifier of the traffic domain assigned to the endpoint-facing port via which the packet entered the network.
Based on the domain identifiers in the packets, permitting forwarding of packets only within each traffic domain.

In one example, processor 48 configured switches 32 by scanning the entries of mapping 60 (FIG. 3). For each entry, processor 48 configures the switch specified in the entry (DeviceID) to mark packets entering via the endpoint-facing port specified in the entry (PortNumber) with the domain identifier specified in the entry (PartitionID).

Stages 82-90 of the method are carried out by switches 32 of network 24, after having been configured by processor 48.

At a packet reception stage 82, a certain switch 32 receives a packet from a certain EP 28 via a certain endpoint-facing port. At a marking stage 86, the switch marks the packet with the domain identifier of the traffic domain that is assigned to the endpoint-facing port.

At a forwarding stage 90, the switch forwards the packet, while guaranteeing that the packet is forwarded only within its assigned traffic domain. For example, before forwarding a packet to a certain endpoint-facing port, in some embodiments the switch verifies that the endpoint-facing port matches the domain identifier of the packet. If not, the packet is discarded.

The flow of FIG. 4 is an example flow that is depicted purely for the sake of conceptual clarity. Any other suitable method flows can be used in alternative embodiments.

### On-The-Fly Modification of Traffic Domain Hierarchy

In some embodiments, processor 48 of NMS 40 may modify the hierarchy of traffic domains on the fly, i.e., during operation of network 24 and with minimal disruption to the network performance. Modification of the hierarchy may comprise, for example, adding a new traffic domain to the hierarchy, terminating an existing traffic domain, merging two or more traffic domains into a single traffic domain, splitting a traffic domain into two or more separate traffic domains, adding endpoint-facing ports such as upon adding a switch to the network, deleting endpoint-facing ports such as upon removing a switch from the network, changing the assignment of endpoint-facing ports to traffic domains, etc. For any such modification, processor 48 typically updates hierarchy 56 and/or mapping 60, and also reconfigures switches 32 as appropriate.

In one example, in response to adding a traffic domain, processor 48 performs the following:
Define a location of the new traffic domain in hierarchy 56.
Define a domain identifier for the new traffic domain.
Update the assignment of the endpoint-facing ports (mapping 60) to account for the new traffic domain.
Reconfigure switches 32 to account for the new traffic domain.

When an existing traffic domain is sub-divided into sub-domains, processor 48 allocates new unique domain identifiers to each sub-domain. Network resources previously associated with the original traffic domain are reassigned to the respective sub-domains, ensuring seamless integration. Messages originating from the newly created sub-domains utilize the newly assigned domain identifiers for accurate forwarding and isolation.

In another example, in response to terminating a traffic domain, processor 48 performs the following:
Remove the traffic domain from hierarchy 60.
Release the domain identifier that was assigned to the traffic domain. The released domain identifier is typically not used again.
Reconfigure switches 32 to account for removal of the traffic domain.

The network resources associated with the terminated traffic domain are reallocated back to the parent traffic domain, preserving resource efficiency. For systems with a limited range of domain identifier values, a reserved pool of identifiers can be allocated to specific traffic domains or to specific levels of the hierarchy. Traffic domains within such levels will draw their domain identifiers from the reserved pool, ensuring scalability and efficient resource management.

The configurations of system 20 and its components, e.g., network 24 and NMS 40, as depicted in FIG. 1, are example configurations that are chosen purely for the sake of conceptual clarity. Any other suitable configurations can be used in alternative embodiments.

Typically, each switch 32 in network 24 comprises (i) multiple ports and (ii) switch circuitry. The ports (endpoint-facing ports and/or inter-device ports) receive and transmit packets. The switch circuitry carries out the various processing tasks of the switch, including, in some embodiments, being configured by NMS 40, marking packets with domain identifiers in accordance with the configuration of NMS 40, and maintaining forwarding-isolation using the domain identifiers. In a typical implementation, the switch circuitry comprises (i) a controller, e.g., a CPU and (ii) forwarding circuitry, e.g., a forwarding Application-Specific Integrated Circuit (ASIC), that forwards packets between the ports. In the context of the disclosed techniques, the controller receives the appropriate configuration from NMS 40, and configures and controls the forwarding circuitry accordingly. The controller may run additional tasks, e.g., a Border Gateway Protocol (BGP) in an InfiniBand switch.

In various embodiments, system 20 and its components, e.g., network 24 and NMS 40, may be implemented using suitable software, using suitable hardware such as one or more Application-Specific Integrated Circuits (ASIC) or Field-Programmable Gate Arrays (FPGA), or using a combination of hardware and software.

In some embodiments, certain elements of system 20, e.g., processor 48 of NMS 40, are implemented using one more general-purpose processors, which are programmed in software to carry out the techniques described herein. The software may be downloaded to the processors in electronic form, over a network, for example, or it may, alternatively or additionally, be provided and/or stored on non-transitory tangible media, such as magnetic, optical, or electronic memory.

### Example System Use-Case

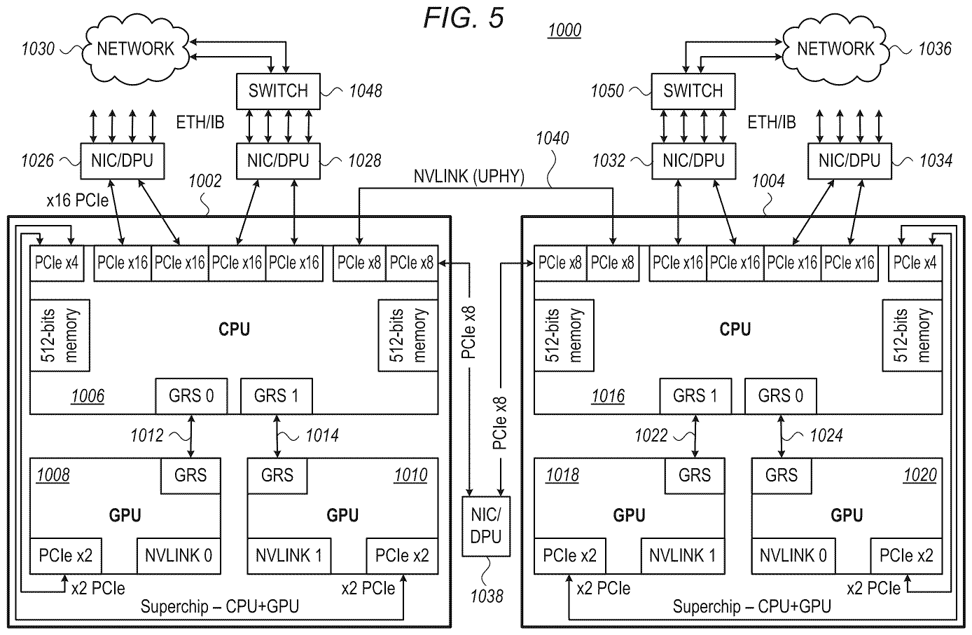

FIG. 5 is a block diagram that schematically illustrates a computing system 1000, e.g., a data center or a High-Performance Computing (HPC) cluster, in accordance with an embodiment described herein. System 1000 comprises a plurality of subsystems, e.g. multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036. In the present example, system 1000 comprises a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 5 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 5, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 5, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communication with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects.

The packet switches in FIG. 5 may comprise, for example, Nvidia Quantum-2 switches. The NICs/DPUs in the figure may comprise, for example, Nvidia Bluefield DPUs. In various embodiments, system 1000 may employ a multi-level hierarchy of traffic domains according to the disclosed techniques.

Although the embodiments described herein mainly address partitioning of network traffic into a hierarchy of traffic domains in network switches and NMSs, the methods and systems described herein can also be used in other applications, such as in partitioning traffic of an MPLS tunnel into a hierarchy of sub-domains. This technique can be applied, for example, in an MPLS router. In such embodiments, an MPLS tunnel may be regarded as a domain. A given tunnel may be divided into sub-domains. Each sub-domain has a different outer label, rather than stacked labels.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A Network Management System (NMS), comprising:
one or more network interfaces, to communicate with a communication network comprising multiple network devices, the network devices being connected (i) to one another via inter-device ports and (ii) to network endpoints via endpoint-facing ports; and
one or more processors, to:
define a plurality of traffic domains arranged in a hierarchy having two or more levels;
associate the endpoint-facing ports of the network devices with respective ones of the traffic domains; and
configure the network devices (i) to assign incoming packets to the respective traffic domains that are associated with the endpoint-facing ports via which the incoming packets enter the communication network, and (ii) to permit forwarding of packets only within each of the traffic domains.

2. The NMS according to claim 1, wherein the one or more processors are to configure the network devices to mark an incoming packet with a domain identifier that is (i) indicative of a traffic domain assigned to the incoming packet, but (ii) not indicative of the hierarchy.

3. The NMS according to claim 1, wherein, in response to adding a traffic domain to the plurality, the one or more processors are to (i) define a location of the traffic domain in the hierarchy, (ii) define a domain identifier for the traffic domain, (iii) update association of the endpoint-facing ports to account for the traffic domain, and (iv) reconfigure the network devices to account for the traffic domain.

4. The NMS according to claim 1, wherein, in response to terminating a traffic domain in the plurality, the one or more processors are to (i) remove the traffic domain from the hierarchy, (ii) release a domain identifier that was assigned to the traffic domain, and (iii) reconfigure the network devices to account for removal of the traffic domain.

5. A network device, comprising:
multiple ports for sending and receiving packets to and from a communication network, one or more of the ports serving as endpoint-facing ports for connecting to endpoints of the communication network;
forwarding circuitry, to forward the packets between the ports; and
a controller, to:
receive a configuration from a Network Management System (NMS); and
responsively to the configuration, configure the forwarding circuitry (i) to assign incoming packets, entering the network device via the endpoint-facing ports, to respective traffic domains that are associated with the endpoint-facing ports via which the incoming packets enter the network device, and (ii) to permit forwarding of the packets only within each of the traffic domains.

6. The network device according to claim 5, wherein, responsively to the configuration, the forwarding circuitry is to mark an incoming packet with a domain identifier that is indicative of a traffic domain assigned to the incoming packet.

7. A network management method, comprising:
defining a plurality of traffic domains for a communication network comprising multiple network devices that are connected (i) to one another via inter-device ports and (ii) to network endpoints via endpoint-facing ports, the traffic domains being arranged in a hierarchy having two or more levels;
associating the endpoint-facing ports of the network devices with respective ones of the traffic domains; and
configuring the network devices (i) to assign incoming packets to the respective traffic domains that are associated with the endpoint-facing ports via which the incoming packets enter the communication network, and (ii) to permit forwarding of packets only within each of the traffic domains.

8. The method according to claim 7, wherein configuring the network devices to assign the incoming packets to the traffic domains comprises configuring the network devices to mark an incoming packet with a domain identifier that is (i) indicative of a traffic domain assigned to the incoming packet, but (ii) not indicative of the hierarchy.

9. The method according to claim 7, and comprising, in response to adding a traffic domain to the plurality, (i) defining a location of the traffic domain in the hierarchy, (ii) defining a domain identifier for the traffic domain, (iii) updating association of the endpoint-facing ports to account for the traffic domain, and (iv) reconfiguring the network devices to account for the traffic domain.

10. The method according to claim 7, and comprising, in response to terminating a traffic domain in the plurality, (i) removing the traffic domain from the hierarchy, (ii) releasing a domain identifier that was assigned to the traffic domain, and (iii) reconfiguring the network devices to account for removal of the traffic domain.

11. A communication method, comprising:
in a network device comprising multiple ports for sending and receiving packets to and from a communication network, one or more of the ports serving as endpoint-facing ports for connecting to endpoints of the communication network, receiving a configuration from a Network Management System (NMS); and
responsively to the configuration, (i) assigning incoming packets, entering the network device via the endpoint-facing ports, to respective traffic domains that are associated with the endpoint-facing ports via which the incoming packets enter the network device, and (ii) permitting forwarding of the packets only within each of the traffic domains.

12. The method according to claim 11, wherein assigning the incoming packets to the traffic domains comprises marking an incoming packet with a domain identifier that is indicative of a traffic domain assigned to the incoming packet.
